(19) United States
(12) Patent Application Publication
(10) Pub. No.: US 2007/0130301 A1
(43) Pub. Date: Jun. 7, 2007

(54) Configuration for substitute-switching spatially separated switching systems

(75) Inventors: Norbert Lobig, Darmstadt (DE); Jurgen Tegeler, Penzberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, MUENCHEN (DE)

(21) Appl. No.: 10/582,403

(22) PCT Filed: Aug. 26, 2004
(86) PCT No.: PCT/EP04/51926

§ 371 Date: Feb. 21, 2007

(30) Foreign Application Priority Data
Dec. 12, 2003 (DE) 10358345.9

(51) Int. Cl. G06F 15/173

(52) U.S. Cl. 709/223

(57) ABSTRACT

An identical clone, with identical hardware, identical software and an identical data base, is allocated to each switching system to be protected, as a redundancy partner. Switching is carried out in a quick, secure and automatic manner in real time by a superordinate monitor in the network.

### CROSS REFERENCE TO RELATED APPLICATIONS

This application is the US National Stage of International Application No. PCT/EP2004/051926, filed Aug. 26, 2004 and claims the benefit thereof. The International Application claims the benefits of German application No. 10358345.9 DE filed Dec. 12, 2003, both of the applications are incorporated by reference herein in their entirety.

### FIELD OF INVENTION

The present invention relates to a configuration for substitute-switching spatially separated switching systems.

### BACKGROUND OF INVENTION

Contemporary switching systems have a high level of internal operational reliability by virtue of the redundant provision of major internal components. Under normal operating conditions therefore (i.e. trouble-free operation, that is to say no external factors affecting operation, no protracted loss of power, etc.), a very high-level availability of the switching-oriented functions is achieved. However, when major external factors affect operation (e.g. fire, natural disasters, terrorist attacks or the effects of military action), the precautions taken to increase operational reliability are generally of little use, because the original and substitute components of the switching system are in the same location. As a result, if a disaster of this kind strikes, it is highly probable that both components will have been destroyed or will no longer be operational.

The result is a lengthy complete failure, as happened on Sep. 11, 2001 in New York, for example. Added to which, extensive logistical and technical effort is required and considerable expertise needed to restore the failed communications function in such a case. In practice, this means that the actual failure can last much longer than would have been necessary for technical reasons. The consequences of this can range from massive financial losses to the paralysis of economic activity or the virtual collapse of the infrastructure, especially in relatively small countries.

The fact that an organization or a society is dependent on or vulnerable as regards properly functioning communications could make switching systems an attractive target for terrorist attacks or even military action.

### SUMMARY OF INVENTION

A solution proposed in the prior art is geographical redundancy where one redundant switching system is to be provided in the network for a plurality of switching systems (l:n redundancy). From the hardware perspective there is therefore a complete, redundant switching system which, under normal circumstances, is offline and has an empty database. The said system is designed so that, with its hardware configuration, it can replace a failed switching system. If one of the n switching systems fails completely therefore, the most recent backup of its database is retrieved, and the redundant switching system is brought into service with this database. Once the redundant switching system has been powered up, it can take over the function of the failed switching system.

This proposal requires only a single redundant switching system for further n switching systems, as a result of which the provision of geographical redundancy is relatively inexpensive for the network operator. However, this advantage has a number of serious associated disadvantages as indicated below.

Thus, it is absolutely imperative for the most recent backup of the failed switching system's database to have remained intact or to have been transferred intact to the location of the redundant switching system. To achieve this, copies of the databases of all the switching systems theoretically to be switched to the backup system must be transferred, or be rapidly transferable, to the redundant switching system at short time intervals (e.g. every week) under normal operating conditions. Whichever technical solution is selected, a considerable amount of work is thus involved, and hence a considerable level of recurring costs.

However, even if the most recent backup of the database has been loaded intact, this will normally never be a complete replica of the failed switching system's database. For example, in the period since the last backup, administrative or configurative changes or the subscriber's own input may have been input into the database and may now be missing. The same applies to the charging information, which is important to the network operator. One particular problem here is the fact that the difference between the database current at the time of failure and the database of the most recent backup is generally unknown, and complete restoration is therefore not possible. There is therefore the risk that the backed-up (old) database may be inconsistent with the databases of the partner switching systems, which may prevent switching-oriented operator control of subscribers and trunks. Successfully powering up a redundant switching system thus by no means ensures that it will operate trouble-free down to subscriber/line level.

Furthermore, the redundant switching system has to be included in any expansion and modification measures undertaken on the other switching systems. The redundant system has to be expanded and structured such that the database of the other switching systems becomes accessible there without limitation or manipulation. The performance requirements must also be equally or better met by the redundant switching system. All this means that the network operator is faced with greater complexity in terms of network planning and the engineering of the network switches and, furthermore, is tied to the same manufacturer at the level of the redundancy unit.

An object of the invention is therefore that of providing a network structure for how a geographical redundancy of switching systems can be developed so that, in the event of a fault, a failed switching system will reliably be switched efficiently over to a redundancy partner.

A substantial advantage of the invention is considered to be the fact that the switchover takes place quickly, reliably and automatically, irrespective of whether the switching system that is to be switched to a backup system has packet-based and/or TDM-based interfaces. This is achieved by assigning, to each switching system that is to be protected, an identical clone as redundancy partner with identical hardware, software and database. The clone is in a powered-up state but is not performing switching functions. A high-availability 1:1 redundancy of switching systems distributed over a plurality of locations is thus defined. The active switching system and its redundancy partner are controlled over the packet network by a remote primary monitor with real-time capability (i.e. in the seconds range). The said monitor can consist of hardware and/or software. The achievement of the most reliable solution possible is thus conditional on the distinct spatial separation of the active switching system and its redundancy partner, the management system and the monitor.

When the switch is made to the backup system moreover, an address change visible to the communication partners is avoided as needed. As a result, from the perspective of the subscribers and connection lines there is only a brief period of non-availability, thus enabling stable connections to be saved when the switch is made to the backup system. Lastly, any charging data and the subscriber's own input are preserved as far as possible and no incorrect charges are recorded.

A further advantage of the invention is considered to be the introduction of a new “hot standby” state for switching systems. This state is marked by the presence of a current database, active applications—especially switching-oriented processes, and the outward blocking of all switching-oriented interfaces of the clone: this means the full activity of all the components with the exception of the packet-based interfaces (and possibly the execution of switching-oriented changes of state).

With a solution of this kind, the invention is normally also applicable to a system that is just a softswitch or just a TDM switch and to the whole range of hybrid configurations (hybrid switches).

Advantageous developments of the invention are indicated in the dependent claims.

### BRIEF DESCRIPTION OF THE DRAWINGS

The invention is explained in more detail below with reference to an exemplary embodiment shown in the drawing, wherein:

FIG. 1 shows the network configuration according to the invention in the case of a locally redundant monitor;

FIG. 2 shows the network configuration according to the invention in the case of a geographically and locally redundant monitor.

### DETAILED DESCRIPTION OF INVENTION

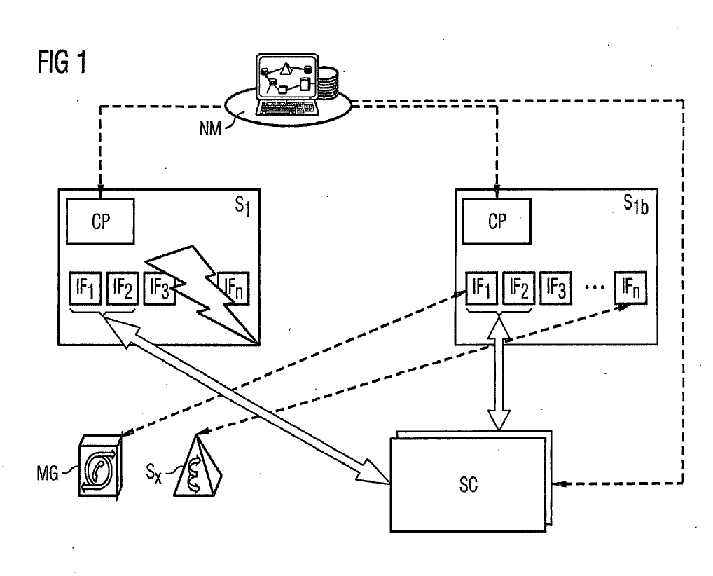

FIG. 1 shows a configuration according to the invention, where each switching system to be protected (e.g. S₁) is assigned an identical clone as redundancy partner (e.g. S_{1b}) with identical hardware, software and database. The clone is in a powered-up state but is not performing switching functions (hot standby operating state). A high-availability 1:1 redundancy of switching systems distributed over a plurality of locations is thus defined.

If the switching systems S₁, S_{1b} have TDM components, at least one cross-connect device CC capable of switching the whole of the TDM traffic between the switching system S₁ and the redundant switching system S_{1b} is also required. Under normal operating conditions, the TDM routes of the switching system S₁ enter or exit at the point CC₁ of the cross-connect device CC and exit or enter again at the point CCₐ. The TDM routes of the switching system S_{1b} enter the cross-connect device CC at the point CC_{1b} or originate there in the return direction. No through-connection is made, however.

According to FIG. 1, both switching systems (switching system S₁ and the clone or redundancy partner S_{1b}) are controlled by the same network management system NM. They are controlled in such a way that the current state of the database and software of the two switching systems S₁, S_{1b} is kept identical. This is achieved by every administration and maintenance command, every configuration command and every software update, including patches, being identically issued to the two partners. A spatially remote, identical clone to a switch in operation, with an identical database and identical software release, is thus defined.

The database normally includes all semi-permanent and permanent data. Here “permanent data” is understood to mean the data which is filed as a code in tables and which can be modified only by means of a patch or software update. The term “semi-permanent data” is understood to mean the data which enters the system, for example via the user interface, and which is stored there for a relatively long time in the form of the input. Except for the configuration states of the system, this data is itself not generally modified by the system. Not included in the database is the transient data accompanying a call, which the switching system stores for only a short time and which is generally of no importance once a call has finished, or status information, which constitutes transient overlays or extensions of configuratively preset base states (a port could thus be active in the base state but momentarily not accessible as a result of a transient (temporary) fault).

The switching systems S₁, S_{1b} also both have at least one active, packet-oriented interface with the common network management system NM. According to FIG. 1, these are the two interfaces IF₁. Here the two interfaces IF₁ are in an active operating state (“act”). However, in the case of the switching system S₁, all the remaining packet-oriented interfaces IF₂ . . . IFn are also active. In the case of the switching system S_{1b}, on the other hand, the remaining interfaces are in the “idle” operating state. Idle means a state where the interfaces do not permit any switching-oriented communication but can be activated externally, i.e. by a primary monitor with real-time capability located outside switching system S₁ and switching system S_{1b}. The monitor can be in the form of hardware and/or software and, in the event of a fault, switches over to the clone in real time. Real time here means a time-span of a few seconds. Depending on the quality of the network, a higher switchover detection time-span can also be defined. According to FIG. 1, the monitor is duplicated in the form of the controlling system SC and to be on the safe side (local redundancy).

The interfaces Iₙ are packet-based and thus constitute communications interfaces with packet-based peripheral devices (for example IAD, SIP proxy devices) and with remote packet-based switches (Sₓ) and packet-based media servers (MG). As can be seen from FIG. 1, they are controlled indirectly by the controlling system SC (switch controller, SC). This means that the controlling system SC can activate and deactivate the interfaces IFₙ and can thus switch back and forth at random between the “act” and “idle” operating states.

The configuration according to FIG. 1 is intended to represent the default configuration. This means that switching system S₁ is performing switching functions, while switching system S_{1b} is in a hot standby operating state. This state is marked by a current database and full activity of all the components with the exception of the packet-based interfaces (and possibly the execution of switching-oriented changes of state). The (geographically redundant) switching system S_{1b} can thus be rapidly transposed into the active switching state by the controlling system SC by virtue of the activation of the interfaces IF_{2 . . . n}.

If TDM information flows are transmitted or received by the switching system S₁, a cross-connect device CC is required. The said device also has (at least) one packet-based (always active) interface IF_{cc} and is connected both to the network management system NM and optionally to the controlling system SC. The controlling system SC and network management system NM can switch the cross-connect device CC over at any time (the controlling system SC under normal conditions and the network management system NM in emergencies). An important aspect is considered to be the fact that the two geographically redundant switching systems S₁, S_{1b}, and the network management system NM and the duplicated controlling system SC, must each be distinctly spatially separate.

The controlling system SC communicates to the network management system NM regularly or as needed on request the current operating state of the switching systems S₁ and S_{1b} (act/standby, state of the interfaces) and its own operating state. The functions of the controlling system SC can optionally be partly or even wholly performed by the network management system NM. To be on the safe side, the network management system NM should also be capable of completing the above-described switchovers manually. Automatic switchover can optionally be blocked, with the result that the switchover can only be carried out manually.

The switching systems S₁ and S_{1b} themselves can also regularly check whether their packet-based interfaces are active. If that is not the case for the interfaces IF_{2 . . . n}, it can be indirectly concluded that a hot standby state exists and certain alerts generated by the non-availability of the interfaces IF_{2 . . .} n can be selectively blocked. In this way it is also possible to detect the transition of a switch from hot standby to active, which enables selective measures to be taken as appropriate at the start of the switching traffic.

To enable the switchover from switching system S₁ to switching system S_{1b} to be executed as reliably and precisely as possible whenever there is a major failure of switching system S₁, it is recommended that the packet-based interfaces of the switch go into the idle state automatically whenever they lose contact with their central unit (if there is one).

The packet addresses (IP addresses) of the interfaces I_{2 . . . n} of the switching system S₁ and their corresponding partner interfaces of switching system S_{1b} can be identical but do not need to be so. If they are identical, the switchover is perceived only by upstream routers. For the partner application in the network, however, it is completely transparent. A term also used in this context is “IP failover function”. If the protocol controlling an interface permits a switchover of the communication partner to another packet address, as is the case with, for example, the H.248 protocol (a media gateway can independently establish a new connection to another media gateway controller with another IP address), the IP addresses can also be different.

If the switchover from switching system S₁ to switching system S_{1b} was due to a network problem and switching system S₁ has no hardware problems, switchover will also be the correct action, since switching system S₁ was no longer sufficiently accessible and so there was possibly a substantial failure in terms of its switching functions. Thus, the controlling system SC should, as far as possible, be connected to the network in such a way as to effectively preclude isolated failure of the connection between the switching system S₁ and the controlling system SC while the switching system S₁ is still accessible in terms of its switching functions. The switchover of the operating states of switching system S₁ and switching system S_{1b} (act ->stb or stb ->act) can also be coordinated by the central parts (CP) of the switches.

According to a development of the invention, the controlling system SC used is the central computer of a further switching system. Thus a controlling system with the highest availability then exists. The functionality of the controlling system SC can also be reduced to simple detection of the need for the switch to a backup system. Initiation of the switchover is thus carried out over the network management system NM, that is to say, is shifted to the operator. This means that upstream multiplexers and cross-connect devices then no longer have to be controlled by the controlling system SC either.

According to a development of the invention, a direct communications interface can be established between switching system S₁ and switching system S_{1b}. The said interface can be used for updating the database, e.g. in respect of SCI (Subscriber Controlled Input) and charging data, and for the exchange of transient data of individual connections or essential further transient data (e.g. H.248 Association Handle). The disruptions to operations can thus be minimized from the perspective of subscribers and operators.

The semi-permanent and transient data can then be transferred by the active switching system to the redundant standby switching system in a cyclic time-slot pattern (update) or in full after the end of the failure. The advantage of the SCI data update is that the cyclic restore on the standby system is avoided and the standby system always has up-to-date SCI data.

As a result of the update of stack-relevant data, such as the H.248 Association Handle, the transfer of the peripherals to a backup system can be concealed from the peripherals and the failure times can be reduced even further.

The control protocol between the controlling system SC and the cross-connect device CC can be a standard OAM protocol (e.g. SNMP) and can correspond to that of the network management system NM.

A major failure of the switching system S₁ is assumed in the following. Owing to the geographical redundancy, it is highly likely that the clone (switching system S_{1b}) is just as unaffected as the controlling system SC. The controlling system SC identifies the failure of switching system S₁ since a sufficient number of interfaces of switching system S₁ no longer respond.

The controlling system SC, responding to identification of the failure of switching system S₁, switches the geographically redundant switching system S_{1b} into an active operating state and deactivates the remainder of the failed switching system S₁. Following repair or recovery, the said system S₁ goes into the hot standby operating state. Manual intervention may be necessary to load the current database from switching system S_{1b} when powering up switching system S₁. If both controlling systems SC are destroyed, the switchover can also be performed manually from the network management system NM.

The same procedure also works in the two special cases where just a softswitch or just a TDM switch is used. In the first case, the system must just be envisaged without the cross-connect device CC and the associated handling. In the second case, there is only one packet-based interface, namely the interface with the network management system NM. Accordingly, only this interface is monitored by the controlling system SC and used as the switchover criterion. To be on the safe side, the said interface should be physically duplicated for this application. If there is just a TDM switch without any packet-based interface whatsoever, the said switch must be expanded by adding a physically duplicated interface of this kind used solely for monitoring by the controlling system SC.

The solution according to the invention can also be applied to faulted communication between switching system S₁ and the controlling system SC as long as the switching system S₁ is still operational as a platform. The controlling system SC accesses the switching system S₁ over the same routers as the switching traffic. Only the IP core network lies in between. In this case the controlling system SC has no contact with the switching system S₁ but it does with the switching system S_{1b}. The switching system S₁ does, however, still perform switching functions and has contact with its switching-oriented network partners. The controlling system SC, after identifying a (supposed) failure of switching system S₁, now activates the redundant switching system S_{1b} but cannot deactivate switching system S₁.

The switching system S₁ has active interfaces IF and responds to the ARP requests of the routers upstream of the system. However, switching system S_{1b} also has active interfaces IF and responds to the ARP requests of its upstream routers. The same IP addresses might therefore be allocated twice (split brain).

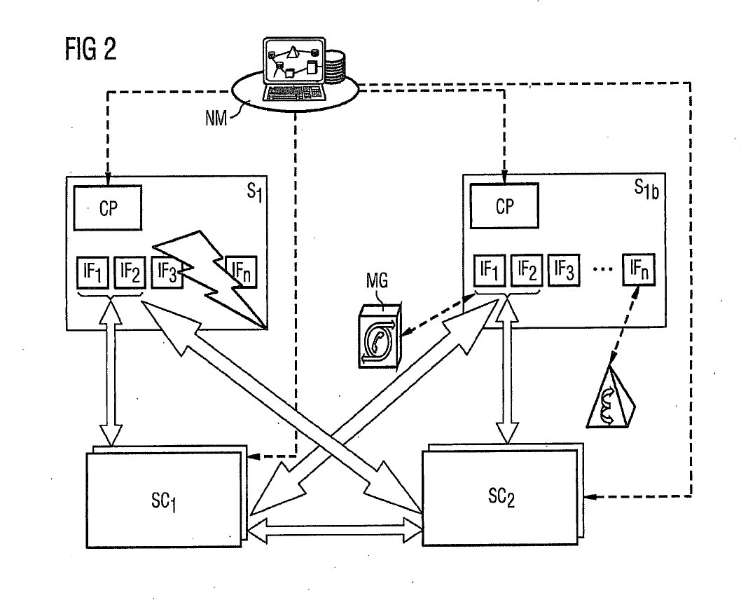

FIG. 2 shows a development of the configuration shown in FIG. 1. According to FIG. 2, two controlling systems SC₁, SC₂ are provided. The difference between this and the configuration shown in FIG. 1 is the provision of two controlling systems SC₁ and SC₂, which are accommodated at different locations. The controlling system SC thus consists of two halves SC₁ and SC₂. Controlling system SC₁ is connected to switching system S₁, S_{1b} and the redundant controlling system SC₂. Controlling system SC₂ is likewise connected to switching system S₁, S_{1b} and to its redundant controlling system SC₁. The two (spatially separated) controlling systems SC₁ and SC₂ monitor each other.

1-12. (canceled)

13. A network configuration for substitute-switching of a switching system, comprising:
a first switching system having access to a transmission network and active from a switching perspective;
a redundant switching system assigned as a redundancy partner to the first switching system, the redundant switching system having access to the transmission network and is inactive from a switching perspective; and
a network management system operatively connected to the first and redundant switching systems;
a real-time monitor operatively connected to the first and redundant switching systems and the transmission network, when a communication to the first switching system fails the real-time monitor causes the redundancy partner to become active from a switching perspective.

14. The configuration according to claim 13, further comprising a plurality of real-time monitors operatively connected to each other.

15. The configuration according to claim 13, wherein first and redundant switching systems have packet base interfaces.

16. The configuration according to claim 15, wherein the first and redundant switching systems have the same packet addresses for the packet-based interfaces.

17. The configuration according to claim 13, wherein the first and redundant switching systems each comprising a database having substantially the same permanent and semi-permanent data.

18. The configuration according to claim 17,
wherein permanent data is data that may only be modified via a software upgrade or a software patch,
wherein semi-permanent data is data entered via a user interface, and
wherein the permanent and semi-permanent data do not include transient data related to a call.

19. The configuration according to claim 17, wherein the first and redundant switching systems have the same hardware and identical software.

20. The configuration according to claim 19, wherein the identical software includes the same software release and software patches.

21. The configuration according to claim 19, wherein the first switching system, the redundant switching system, the network management system and the real-time monitor reside at different geographical locations.

22. The configuration according to claim 17, wherein the redundant switching system is in an operating state such that all outward-switching-oriented packet-based interfaces are blocked and the system includes active applications.

23. The configuration according to claim 13, wherein the first and redundant switching systems include packet-based interfaces having the same packet addresses.

24. The configuration according to claim 13, wherein the transmission network has a cross-connect device that is controlled by the network management for switching TDM connections.

25. The configuration according to claim 13, wherein the transmission network has a cross-connect device that is controlled by the monitor for switching TDM connections.

26. The configuration according to claim 13, wherein the transmission network has a direct communications interface between the first switching system and the redundant switching system.

27. The configuration according to claim 13, wherein the first switching system, the redundant switching system, the network management system and the monitor reside at different geographical locations.

28. A system for monitoring redundant switching system, comprising:
a communication link to a first switching system that is active from a switching perspective;
a communication link to a redundant switching system that is inactive from a switching perspective and that includes substantially the same permanent and semi-permanent data; and
a monitor having real time switch over mechanism that causes the redundant switching system to become active after a failure of the first switching system.

29. The system according to claim 28, further comprising a plurality of monitors that monitor each other and that coordinate the switch over.

30. The system according to claim 29, wherein the monitors do not switch between paired-redundancy switching systems in the event of faulted intercommunication.
